(19) United States
(12) Patent Application Publication
(10) Pub. No.: US 2007/0136741 A1
(43) Pub. Date: Jun. 14, 2007

(54) Methods and systems for processing content

(76) Inventor: Keith Stattenfield, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/298,407

(22) Filed: Dec. 9, 2005

(51) Int. Cl. H04N 7/10

(52) U.S. Cl. 725/32

(57) ABSTRACT

Exemplary embodiments of methods and apparatuses to detect and process a repeating content are described. The repetition in the content is determined. Then the repeating content is identified thereby providing the ability to remove or to not present the repeating content. The repeating content may be removed while the information about the repeating content is preserved. An identified repeating content may be used to identify the repeating content in other content. Segments in the content are allocated. The segments are processed to yield an identifier for each of the segments. Identifiers in a sequence of the segments are compared with the identifiers in the sequence of the segments that have been processed. The repeating portion in the content is identified as a repeating content if the identifiers in the sequence of the segments match with the identifiers in the sequence of the segments that have been processed.

### FIELD

Embodiments of the invention relate to processing of the information. More particularly, embodiments of the invention relate to methods and apparatuses that detect and process a redundant content.

### BACKGROUND

Since ancient times the progress in technology drives development of various media of communication to reach ever larger audiences. Physical duplication technologies e.g., printing, record pressing, and film duplication, allowed the duplication of books, newspapers, and movies at low prices to thousands of people. Television and radio provide the electronic duplication of content to even larger audiences than physical duplication technologies. The advent of the World Wide Web provides an opportunity to expose the information on a global scale.

From the early days mass media has been used as a vehicle for advertising. Radio, television, and the Internet have become effective, persuasive, and popular tools for advertising. A typical radio or TV broadcast includes a portion of a programming content with a portion of an advertising content. Advertisings paid by a sponsor to promote and sell various sorts of products are called commercials. Non-commercial advertisings, e.g., public service advertisings, are used to inform, educate, and motivate people about non-commercial issues, e.g., AIDS, political ideology, energy conservation. Over the years, advertisings occupy more and more time with respect to the programming. The vast majority of advertisings today consist of brief advertising spots ranging in length from a few seconds to several minutes that are interspersed among the original content of programming. Advertisings are repeated many times over the course of TV or radio broadcasting. Repeating advertisings not only may distract one's attention from the original programming content, but also may be irritating.

Some videocassette recorders (“VCRs”) have an option of skipping the commercials on a video tape by looking for certain frames in a recorded video signal, such as blank video frames. Normally, there are two to three blank video frames in a television signal at the beginning of a commercial, and one blank video frame is at the end of the commercial. Such VCRs use an approximation that each of TV commercials has a duration of a multiple of 15 seconds, or 30 seconds, such that the total duration of consequent commercials within a single time block is about 6 minutes. When the VCR encounters a blank frame, it starts to fast forward a part of a video tape over around next 6 minutes of recording assuming that the next 6 minutes of recording are commercials. After fast forwarding, the VCR resumes playing the video tape. Because the duration of commercials and programmings can vary, methods used in VCRs are unreliable and inaccurate.

Another method was used in the past to detect commercials in black and white movies. Because commercials were played in color, and movies were played in black and white, a method recognized commercials when a color synchronization was detected. Because both programming content and commercials are now in color, color synch signal method of detecting commercials can not be used.

Currently, what is needed are reliable and accurate methods to detect and process advertising content interspersed among the original programming content. Additionally, it may be desirable to acquire and attend to the advertising content when and where one wants to.

### SUMMARY OF THE DESCRIPTION

Exemplary embodiments of methods and apparatuses to detect and process a repeating content are described herein. First, the repetition in the content is determined. For example, a first sequence of audiovisual data, in a first time interval of a first content (e.g., a first TV show), is determined to repeat in the same first content (the first TV show) at a different time interval or is determined to repeat in another content (e.g., the repeating content is in a second TV show). Then the repeating content (e.g., a TV commercial) is identified thereby providing the ability to not present the repeating content, present the repeating content differently, or remove the repeating content. In one embodiment, after being identified, the repeating content may be removed while the information (e.g., a series of checksums) about the repeating content may be preserved. In another embodiment, after being identified, the repeating content may be sped up, or skipped, while the information about the repeating content may be preserved. In yet another embodiment, after being identified, the repeating content may be presented differently, e.g., muted, dimmed, sped up, substituted with another content and/or data, and/or sped up, while the information about the repeating content may be preserved.

In one embodiment, the identified repeating content may be skipped while presenting an non-repeating content. In another embodiment, the identified repeating content may be presented a certain number of times (and thereafter not presented again). In one embodiment, the identified repeating content may be stored. In one embodiment, the identified repeating content may be used to identify the repeating content in other content. For example, the identified repeating content (e.g., a first commercial) in a first TV show may be used to identify repeating content in a second TV show. In one embodiment, the information about the repeating content in a first content, e.g., in an audio or video content, may be used to modify a second content, e.g., a video or audio content that corresponds to the first content. In one embodiment, the information about the repeating content is shared between a plurality of central processing units (“CPUs”) or data processing systems.

One specific exemplary embodiment may operate in the following way. First, segments in the content are allocated or selected. The segments may be, for example, video frames in the video stream content, or snippets of sound in the audio stream content. Then the segments are processed to yield an identifier, e.g., a checksum, for each of the segments. Identifiers in a first sequence of the segments are compared with the identifiers in the sequence of the segments that have been processed. The repeating portion in the content is identified as a repeating content if the identifiers in the sequence of the segments match with the identifiers in the sequence of the segments that have been processed. A list of the identifiers in the sequence of the segments that have been processed may be composed and stored. The identifiers in a next sequence of the segments are compared with the identifiers in the list to see if the identifiers in the next sequence match with the identifiers in the list.

### BRIEF DESCRIPTION OF THE DRAWINGS

The present invention is illustrated by way of example and not limitation in the figures of the accompanying drawings in which like references indicate similar elements.

FIG. 1 is a flowchart of one embodiment of a method to automatically detect and process a repeating content.

FIG. 2 is a flowchart of one embodiment of a method to automatically detect and process repeating segments in content.

FIG. 3 is a flowchart of one embodiment of a method to automatically detect and process repeating segments in a video content.

FIG. 4 shows one embodiment of calculating identifiers for a sequence of video frames.

FIG. 5 shows one embodiment of comparing the identifiers for a content to be examined with the identifiers in a list, which represents repeating content.

FIG. 6 is a flowchart of one embodiment of a method to automatically detect and process repeating segments in an audio content.

FIG. 7 is a flowchart of one embodiment of a method to automatically detect and process repeating portions in content.

FIG. 8 is a flowchart of one embodiment of a method to automatically detect and process a repeating content including audio and video content.

FIG. 9 is a flowchart of another embodiment of a method to automatically detect and process a repeating content including audio and video content.

FIG. 10 shows a block diagram of one embodiment of a device that automatically detects and processes a repeating content.

FIG. 11 shows a block diagram of one embodiment of a system that automatically detects and processes a repeating content.

FIG. 12 shows a block diagram of another embodiment of a system that automatically detects and processes a repeating content.

FIG. 13 shows a block diagram of one embodiment of a system that automatically detects and processes a repeating audio content.

### DETAILED DESCRIPTION

The subject invention is described with reference to numerous details set forth below, and the accompanying drawings illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

Exemplary embodiments of methods and apparatuses to automatically detect and process a redundant (“repeating”) content are described below. First, the repetition in the content is determined. Then the repeating content is identified thereby providing the ability to not present the repeating content, present the repeating content differently (e.g., dimmed or muted), or remove the repeating content. In one embodiment, after being identified, the repeating content may be removed while the information about the repeating content may be preserved. In another embodiment, after being identified, the repeating content may be sped up, or skipped, while the information about the repeating content may be preserved. In yet another embodiment, after being identified, the repeating content may be presented differently, e.g., muted, dimmed, and substituted with another content while the information about the repeating content may be preserved.

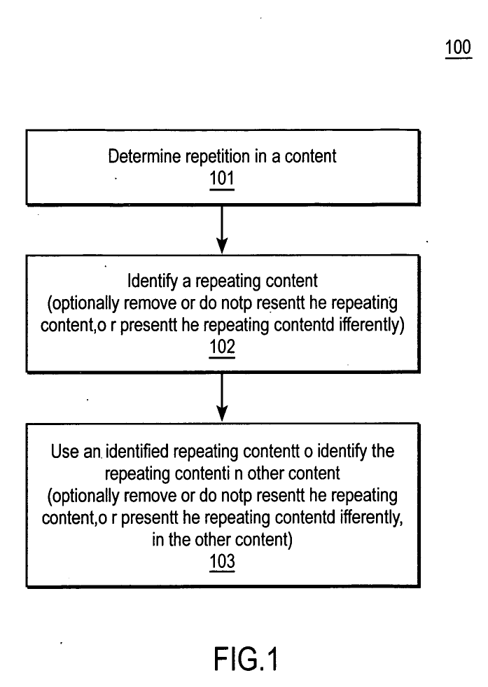

FIG. 1 is a flowchart of an embodiment of a method to automatically detect and process a repeating content. The method 100 begins with determining in operation 101 a repetition in content. For example, for any stream of content, advertisings tend to repeat with a frequency much higher than the rest of the content. In certain particular recorded radio shows on an iPod produced by Apple Computer, Inc in Cupertino, Calif., about 25 same commercials are repeatedly run. For example, the advertising may repeat every 15 to 25 minutes and last between about 15 seconds to about 9 minutes during a show. In one embodiment, the content may be a static media content, a streaming media content, an audio data stream, a video data stream, static files, content of a web page, and the like. In one embodiment, the repeating content may include advertising, public service messages, and the like. Method 100 continues with an operation 102 of identifying the repeating content so that future occurrences of that repeating content may be removed or not be presented. At operation 103 an identified repeating content, e.g., advertising, is used to identify the repeating content in other content, e.g., in another show, so that future occurrences of the repeating content may be removed or not presented in other content. In one embodiment, the repeating content identified in a previous show is used to identify the same repeating content in a current show. In this description, the word “show” is meant to include any media content, including, for example, audio content, or audio and video content, or tactile (e.g., Braile) presentations and/or content and any combinations of such content.

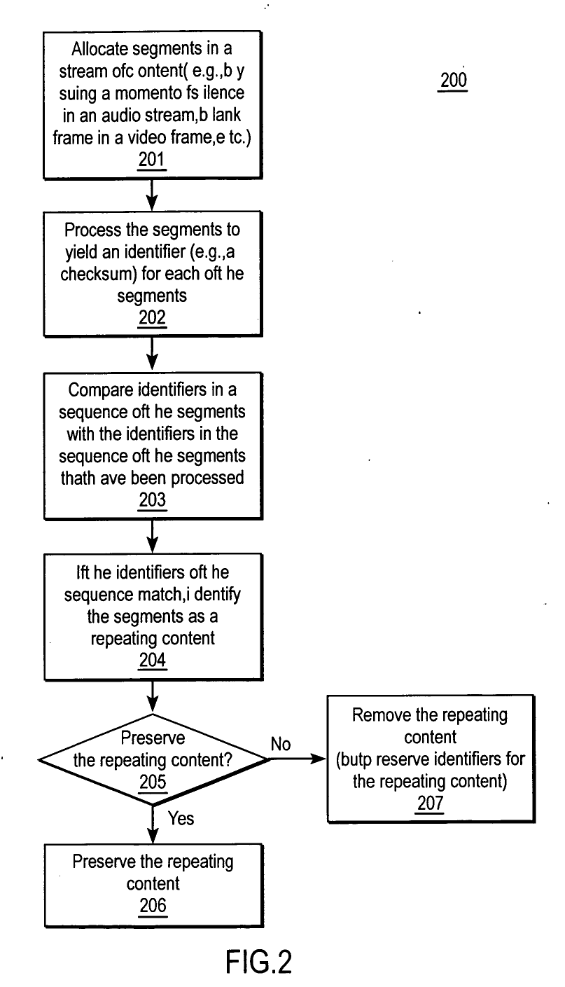

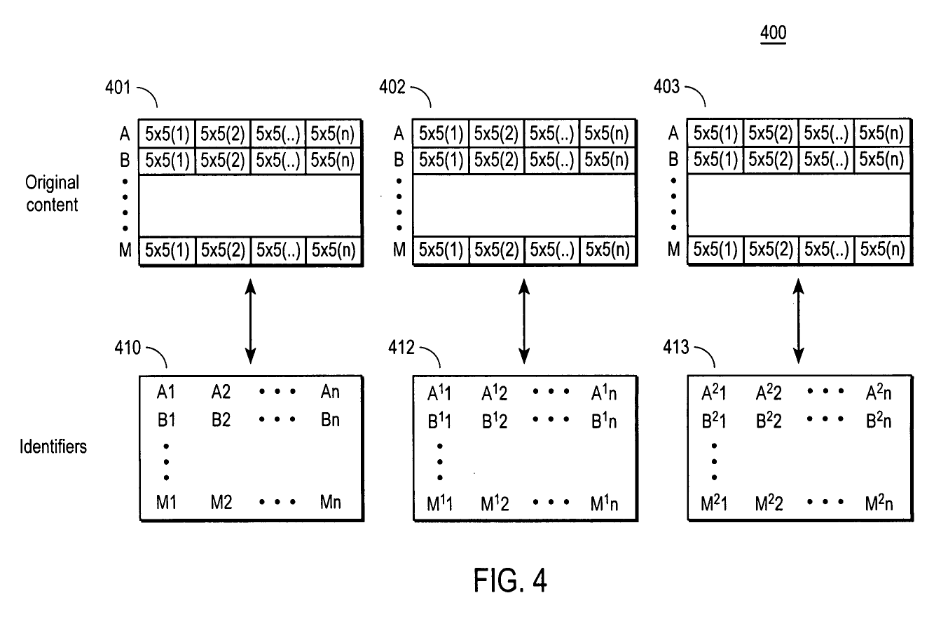

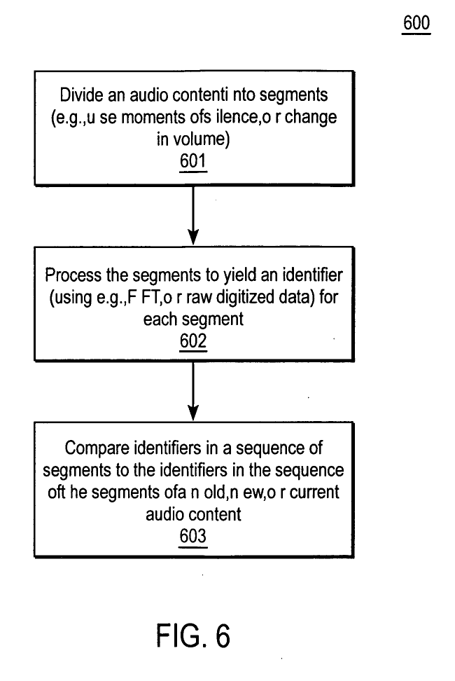

FIG. 2 is a flowchart of one embodiment of a method to automatically detect and process repeating segments in content. Method 200 begins with an operation 201 of allocating or selecting segments in a stream of content. The segments may be video frames in a video stream content, snippets of sound in audio stream content, or any combinations thereof. In one embodiment, the segments are allocated or selected based upon moments of silence in an audio stream of data or an audio signal. In another embodiment, the segments are allocated or selected based upon moments of changing volume in an audio stream of data, or audio signal. In another embodiment, the segments are allocated or selected based upon blank or black frames in a stream of video data or video signal. In each of these examples, the selections or allocations attempt to identify segments, which have logical beginnings; in other words, operation 201 attempts to break the stream of content into segments for further analysis, wherein the breaking relies upon the fact that there are normally separators (e.g., silence and/or blank/black video frames) between the “desired” content and the repeating content, which is presumably a commercial or public service content. Next, at operation 202 the segments are processed to yield identifiers for each of the segments. In one embodiment, processing includes calculating an identifier, e.g., a checksum, for each of the segments. A checksum may be a computed value, which depends on the contents of a block of data. The checksum may be a small number of bits produced from a large block of data, e.g. a packet of network traffic, a block of a computer file, a stream of video and/or audio data, or any combination thereof. The checksum may be transmitted or stored along with the data in order to detect corruption of the data, for example, in transmission or storage. The checksum may have the size of 4, 8, 16, 32, 128 bits, or some other size. The checksum may be created by calculating the binary values in a block of data using some algorithm, and storing the results with the data. For example, checksums may be computed by adding up the basic components of each of the segments, e.g. bytes or words of the data block, and storing the resulting value in a memory. In one embodiment, for radio content, a checksum may be calculated, after a moment of silence, for each of the small snippets of sound, and the resulting value for each of the small snippets of sound may be stored in the memory. In another embodiment, to process video frames, checksums may be calculated by, e.g., adding up red, green, blue (“RGB”) values of sxs (e.g., 5×5) pixel rectangles, as described in further detail below with respect to FIG. 4. In another embodiment, to process segments of audio streaming content, direction of changes in volume, amplitude of an audio signal, or raw digitized data may be used to calculate a checksum, as described in further detail below with respect to FIG. 6. In another embodiment, the identifier of each of the segments may be a close captioning information at the bottom of the video frame, the illuminance of the image, or the combination thereof. An analysis of the content in commercials may also be used to identify commercials; speech recognition bay be used to perform this analysis. In yet another embodiment, an audio content may be analyzed using a speech recognition method and/or for words and then segments may be identified based on the words. For example, the segments may be identified based on one or more words used in the content, on how often the certain words are repeated in the content, on a position of certain words in the content, and any combination thereof. Speech recognition may be used to initially detect content (e.g. commercials) which will be repeated and/or to detect content which is being repeated.

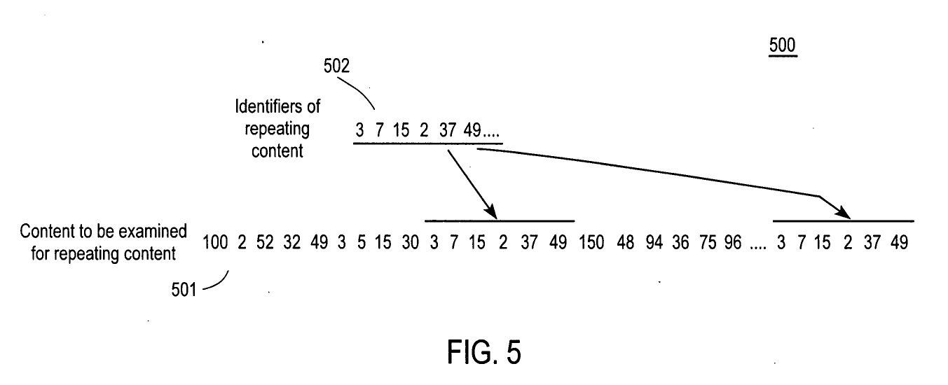

Operation 203 involves comparing the identifiers in a sequence of the segments with the identifiers in the sequence of the segments that have been processed. For example, as the segments are processed through the stream of content to yield an identifier, if another segment is found, which has the identifier seen earlier in the processing, the matching of the identifiers for the following sequence of the segments is performed against the identifiers in the sequence that has been processed earlier. An exemplary method of comparing the identifiers is described in further detail below with respect to FIG. 5. Thus, operation 203 is normally comparing one set of identifiers (normally identified as repeating or potentially repeating) with another set of identifiers.

Next, at operation 204, if the identifiers in the sequence of the segments match, the sequence of the segments is identified as a repeating content. In at least certain embodiments, a match between two sets of identifiers is not regarded as identifying repeating content unless the match has sufficient length or duration. In other words, a match of merely one or two identifiers in the two sets is normally not regarded as repeating content which represents a commercial. For example, there may be segments, e.g., video frames, in different places of the video stream that are the same, but they may not represent repeating content because a video frame before, and the video frame after a current video frame are different than another sequence of video frames. In one embodiment, to identify the repeating content, a sequence of the segments having a predetermined length, e.g. 3 to 5 video frames, may be required. In an embodiment, the sequence of the video frames identified as the repeating content, has at least three consecutive matching video frames. In another embodiment, the minimum length or duration may be 300 or 600 or 900 or 1800 consecutive video frames. In one embodiment, the minimum length or duration may be about 95% of about 200 first consecutive video frames.

In another embodiment, the sequence of the matching segments considered as the repeating content has a predetermined minimum duration, e.g., 1 to 30 seconds. More specifically, the minimum duration may be 2 to 15 seconds. For example, original music videos may include other music videos that occupy about 1 to 3 seconds of time in the original content.

In one embodiment, the sequence of the matching segments considered as the repeating content has a maximum length, or maximum duration above which is not worth looking for repeating content. For example, if a yesterday's TV show that lasts a half an hour is repeated today, it may not be considered as the repeating content that needs to be removed. In an embodiment, the user or a system, such as a system under a software or hardware control, may specify one or more times when to start and when to finish comparing the identifiers in the sequence of the segments. For example, user may ask to perform comparing the identifiers in the sequence of the video frames from 15 seconds to one hour from the starting video frame. In one embodiment, the maximum and the minimum lengths (or durations) of the sequence of matching segments may be considered as filters that prevent from accidental removal of unrepeating portions in the content.

Next, at operation 205 determination is made if the repeating content needs to be preserved. If the repeating content does not need to be preserved, the repeating content is removed at operation 207. In one embodiment, the repeating content is removed, but the identifiers for the repeating content are preserved (for example, the sequence of identifiers of the repeating content may be saved for use in searching for, through a comparison operation as in operation 203, other instances of the same repeating content). In one embodiment, a list of identifiers for the repeating content preserved in a memory is shared between a plurality of users, e.g., between a plurality of personal computers. If repeating content is to be preserved, at operation 206 the repeating content is stored in the memory.

It will be appreciated that the method of FIG. 2 may be performed as a “one content only” (e.g., one TV show) implementation or as a several different contents implementation (e.g., several different shows). For example, the case of a one content only implementation may involve searching for (e.g. through comparison operations) repeating content, which represents a commercial, within the same TV show, using the content from only that TV show. This would occur where, for example, the same commercial is repeated within same TV show. In this case the comparisons are performed with the same content in order to find repeating commercials within that content. This implementation will not find commercials, which do not repeat within the same show, because the comparisons are using content from only that show. Of course, the sequence of identifiers which represent those repeating commercials can be used to find/identify those repeating commercials in other content, such as another TV show. By saving the sequences of identifiers which represent commercials in various different shows, it is possible to build a database or storage of such sequences of identifiers which can be used to search through different content to identify commercials, or similar content, within the different content, and an embodiment of method 200 may use such a database or storage when doing the comparison. A “several different contents” implementation may search for repeating content with the several different contents (e.g., several different TV shows) in order to build the database or storage. Thus, this implementation could find a commercial which appears once in each of two different TV shows or other contents.

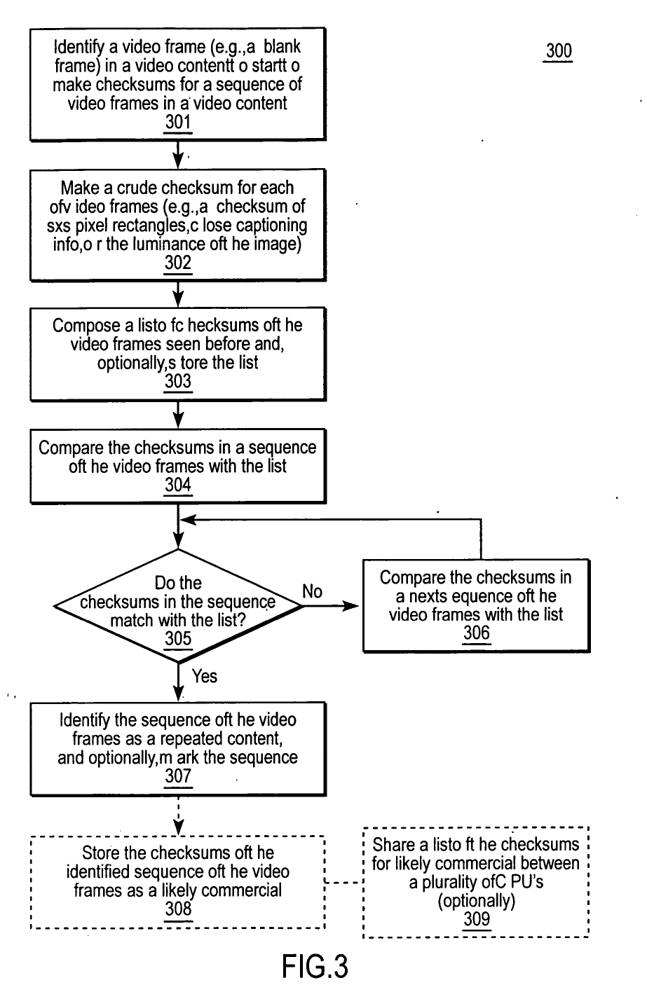

FIG. 3 is a flowchart of one embodiment of a method to automatically detect and process repeating segments in a video content. A method 300 begins with operation 301 of identifying a starting video frame for a sequence of video frames to be examined on a repeating content. In one embodiment, operation 301 may be used to optimize method 200 described with respect to FIG. 2. The starting video frame may be, e.g., a blank video frame in a video stream, which determines the part of the video content at which to start making checksums for the sequence of video frames. Method 300 continues with operation 302 making a crude checksum for each of video frames that follow the starting video frame. The crude checksum reduces the amount of information in each video frame to make the information manageable, but does not dilute the information so much that two different video frames look the same.

FIG. 4 illustrates one embodiment of calculating identifiers for the sequence of the video frames. FIG. 4 shows starting video frame 401 and following video frames 402 and 403. Each of video frames 401, 402, and 403 has an array of SxS, e.g., 5×5, pixel rectangles positioned in rows A, B, . . . M. As shown in FIG. 4, starting video frame 401 has an identifier 410, video frame 402 has an identifier 412, and video frame 403 has an identifier 413. Identifier 411 is formed using average values A1 . . . An, B1 . . . Bn, and M1 . . . Mn calculated for each of 5×5 pixel rectangles of video frame 401. An average value may be calculated of each of the pixel values, such as RGB values, of the 5×5 pixel rectangle. Identifier 412 is formed using average values A1¹ . . . An¹, B1¹ . . . Bn¹, and M1¹ . . . Mn¹ calculated for each of 5×5 pixel values of video frame 402. Identifier 413 is formed using average values A1² . . . An², B1² . . . Bn², and M1² . . . Mn² calculated for each of 5×5 pixel rectangles of video frame 401. Then a crude checksum for each of video frames 401, 402, and 403 may be calculated using respective average values A1 . . . An, B1 . . . Bn, and M1 . . . Mn, A1¹ . . . An¹, B1¹ . . . Bn¹, and M1¹ . . . Mn¹, and A1² . . . An², B1² . . . Bn², and M1² . . . Mn². The checksum may be calculated using any algorithm known to one of ordinary skill in the art of data processing, e.g., using an addition algorithm. For example, if the average value of a 5×5 pixel rectangle is above a predetermined amount of bits (“threshold”), or is an even value, a zero is added to a checksum of a video frame. If the average value is below a predetermined threshold, or is an odd value, a one is added to the checksum. The size of identifiers 411, 412, and 413, e.g., the checksum, may be 4 bits, 8 bits, 16 bits, 24, 32, 128 bits, or any other size. In one embodiment, each of identifiers 411, 412, and 413 is a binary number. In alternate embodiments, identifiers 411, 412, and 413 may be crude checksums of close captioning information, which is a sequence of data embedded at the end of each frame, crude checksums of overall luminance, or brightness, of the image, or any combination thereof. In yet another embodiment, a checksum of a video frame may be a video frame. That is, a pixel value of each pixel in the frame is calculated into a checksum. Because of noise in data, a tolerance of the pixel value may be added into a calculation of a checksum, e.g., averaging of sxs pixel rectangles may be performed as described above.

Next, referring back to FIG. 3, at operation 303 a list of checksums of the video frames seen before is composed. The composed list of identifiers may be stored in the memory. Method 300 continues with operation 304 of comparing the checksums in the sequence of the video frames to be examined with the sequence of the checksums on the list.

FIG. 5 illustrates one embodiment of comparing the identifiers for content to be examined with the identifiers on the list. As shown in FIG. 5, content 501 to be examined for repeating content includes a sequence of segments, e.g., video frames, wherein each of the segments has an identifier, e.g., a crude checksum. As shown in FIG. 5, identifiers, e.g., checksums, for each of the segments in the sequence are represented by a sequence, e.g., a string of numbers 100, 2, 52, . . . 49. List 502 of identifiers, e.g., checksums, for the content processed before includes a sequence of numbers 3, 7, 15, 2, 37, and 49. In one embodiment, list 502 is a table, which includes crude checksums for the content processed before. The list 502 may be obtained from the database or storage of sequence of identifiers which have been determined to represent commercials. Each of the identifiers of the content 501 is compared with the sequence of the identifiers in list 502. In one embodiment, a first identifier in list 502 is looked up and checked if it occurs in the sequence of identifiers of content 501 to be examined. If the first identifier in list 502 is matched with the identifier of the segment of content 501, then the identifiers of the succeeding segments, are subsequently compared with the identifiers on list 502. When matching sequence 503 of identifiers in content 501 is detected, as shown in FIG. 5, matching sequence 503 is identified as a repeating content. As shown in FIG. 5, content 501 may include another matching sequence 504 of identifiers, which is also identified as the repeating content. It will be appreciated that the matching operation may be performed in hardware (e.g., hardware correlators) or in software or in a combination of hardware and software.

In another embodiment, a video content 501 comes in, and a checksum of a particular video frame is calculated. For example, the checksum value is 3. The value of a calculated checksum may be stored in a shift register. Then list 502 is searched through to determine if there is any checksum 3 on list 502. List 502 may be stored in another shift register. If checksum 3 on list 502 is found, a next video frame that's currently coming in, is processed, and the checksum of the next video frame is calculated. The value of the checksum already processed may be shifted out in the shift register as the next video frame of video content 501 comes along and a next checksum is calculated. For example, the calculated checksum of the next video frame is 7. Then the checksum 7 of the content 501 is matched with a next checksum on list 502. If the next checksum on list 502 is also 7, then checksum of the next frame of video content 501 is calculated and matched with the next checksum on list 502. To identify a repeating content, matching continues for a predetermined amount of time or for a predetermined amount of frames, as discussed above. If, for example, checksums for three to five consequent video frames match with the sequence of checksums on list 502, the repeating content is identified. If checksums for three to five consequent video frames do not match with the sequence of checksums on list 502, the repeating content is not identified. In one embodiment, to verify that a recorded content timely repeats, and to identify the end of the repeating content, some number of video frames in each sample may be checked ahead to verify that the checksums are still match with the checksums on list 502. In one embodiment, matching of sequences of checksums of recorded video frames with the sequences on list 502 may be performed ahead of time, e.g., 5 seconds ahead of playing the recorded content.

Referring back to FIG. 3, method 300 continues with operation 305 of determining whether the checksums in the sequence of video frames examined for a repeating content match with the checksums on the list. If the checksums in the sequence do not match with the checksums on the list, then at operation 306 comparing the checksums in a next sequence of video frames with the checksums on the list is performed. If the checksums in the sequence of the video frames match with the checksums on the list, then at operation 307 the sequence of the video frames is identified as a repeating content. In one embodiment, operation 301 is skipped, such that the checksum of each of the video frames in the video content is compared with the checksums of each of the frames processed before.

In one embodiment, the sequence of the video frames identified as the repeating content is marked for future processing and optimization. For example, a flag, or other indicator, which indicates that the sequence is the repeating content, may be stored together with the repeating content in a memory. Further, method may be continued with optional operation 308 of storing the checksums of the identified sequence of the video frames as a likely commercial in the memory. Optional operation 308 is depicted by a dashed block. Next, at optional operation 309, sharing the list of the checksums for the repeated content, e.g., likely commercial, between a plurality of central processing units (“CPU”s) may be performed as a part of an optimization process. Optional operation 309 is depicted by a dashed block, as shown in FIG. 3.

FIG. 6 is a flowchart of one embodiment of a method to automatically detect and process repeating segments in an audio content. A method 600 begins with operation 601 of dividing the audio content into segments. In one embodiment, moments of silence and/or change in volume in a continuous audio signal or in the audio data stream are used to determine the start of a segment in the audio content. In one embodiment, the moments of silence and/or change in volume may have a predetermined duration, e.g., 1 to 30 seconds, to define the segment in the audio content to be examined on a repeating content. In one embodiment, operation 601 may be used to optimize method 200 described with respect to FIG. 2.

Next, at operation 602 the segments of the audio stream are processed to yield an identifier. In one embodiment, the continuous audio signal, e.g. from a radio broadcast, or from audio player, e.g., an iPod, is divided to intervals. The fast Fourier transform (“FFT”) may be performed on each of the intervals to provide information on a magnitude of an audio signal and/or a direction of change in the audio signal. Sequence of magnitudes and/or directions of changes in the audio signal may be used as identifiers to examine the audio signal on the repeating content. In another embodiment, checksums for each of the segments in the stream of audio data are calculated as described with respect to FIGS. 4-5. Next, at operation 603, the identifiers in the sequence of the segments are compared with the identifiers in the sequence of the segments of an old, new, or current audio content. In one embodiment, the identifiers in the sequence of the segments are compared with the identifiers stored in a memory, which belong the segments of the old content. In another embodiment, for example, for the same audio content, the identifiers in the sequence of the segments are compared with the identifiers in the sequence of the segments processed before. In yet another embodiment, the identifiers of the sequence of the segments are compared with the identifiers of a new content that is presented to the user.

In one embodiment, comparing 603 is performed in a real time while the audio content is broadcasted. In another embodiment, comparing 603 is performed for the audio content that is recorded, e.g. on a MP3 player. For example, an audio content, e.g., MP3 stream, may be downloaded to a computer. The computer performs operations 601-603 to identify a repeating content in the audio content. The computer marks the repeating content in the audio stream. Then the audio player, e.g., an iPod, searches for the marks in the audio stream, and, depending on user's desire, skips the marked content, or plays the marked content. In one embodiment, to compare a magnitude of the audio signal with the magnitude of the audio signal processed before, a predetermined amount, e.g., 1-10%, of a magnitude variation (“delta”) is used. In one embodiment, instead of comparing the identifiers, e.g., the checksums, raw digitized data of the content are aligned and compared with the raw digitized data of the content processed before to identify a repeating content. For example, for a radio signal having a frequency of about 22 kilohertz (“kHz”), raw digitized data rate is about the 22 kHz that provides a sufficient amount of time for a processor to perform comparing the raw digitized data for the audio content.

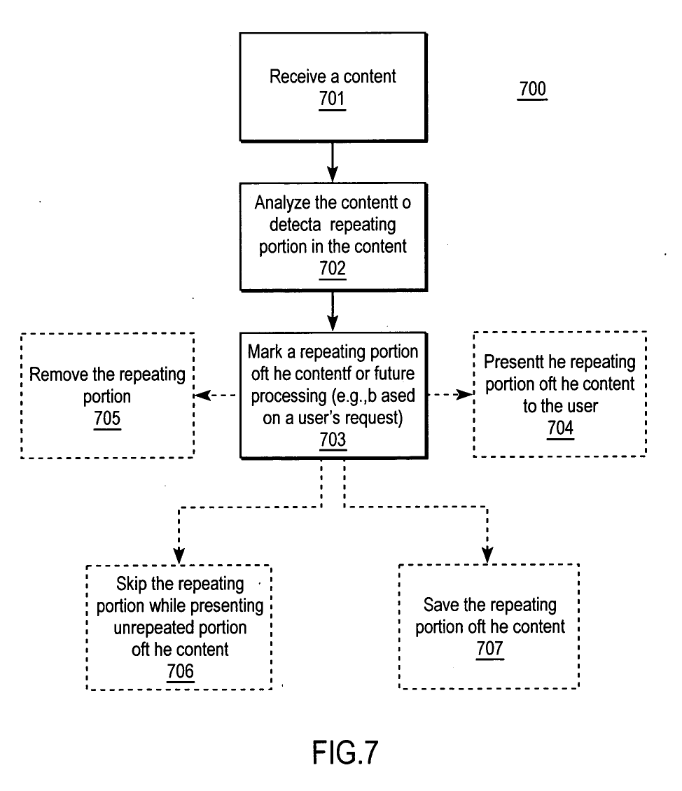

FIG. 7 is a flowchart of one embodiment of a method to detect and process repeating portions in content. Method 700 begins with operation 701 of receiving a stream of content. In one embodiment, the content is a streaming video content, audio content, static files (e.g. already stored media content files, such as files of content of shows), content of a web page, or any combination thereof. Next, at operation 702, the stream of content is analyzed to detect a repeating portion in the content, as described with respect to FIGS. 2-6. Then, at operation 703, the repeating portion of the content is marked for future processing, e.g., depending on a user's request. In one embodiment, the repeating portion of the content is marked using a flag, e.g., a single bit of information, which may be true when the portion of the content is repetitive, or false when the portion of the content is not repetitive, or vice versa.

In one embodiment, marking the repeating portion of the content is performed by marking the repetitive data itself, e.g., by adding a flag, e.g., a single bit of information, to the data. In another embodiment, marking the repeating portion is performed by storing information and/or parameters about the repeating portion in a separate file in a memory. In one embodiment, marking the repeating portion includes storing a repetition rate of the repeating portion, storing a location of the repeating portion in a memory, or both either with the content of the repeating portion or in a separate file in memory. Further, a marked repeating portion of the content may be optionally presented to the user in operation 704. For example, a marked repeating portion of the content may be presented to the user if the user wants to see commercials that have been added to the show lately, or to see most popular music videos added to the programming. In one embodiment, the marked repeating portion may be presented based on one or more parameters which may be stored with the repeating content or in a separate file. The one or more parameters may include an indication of how many times the repeating portion of the content should be displayed or otherwise presented, how the repeating portion is presented (e.g. muted or dimmed), and the like. For example, the one or more parameters may include preferences specified by a user, preferences specified by an author of the repeating content, application specific preferences, or any combination thereof. For example, application specific preferences may be set and/or included in a software, which creates the repeating content, and may be set and/or included in the software, which presents the repeating content. In an embodiment, a repetition rate may be presented to a user together with the marked repeating portion of the content. This may be useful to advertising executives who study commercials. For example, a TV programming may be recorded over a period of time, e.g. a day, and the marked repeating content together with the repetition rate may be presented to the user, who wants to observe how many times the repeating content, e.g., an advertising, is played over the period of time and wants to watch the advertising without watching the full TV programming.

The repeating content may be identified as a live content, as a stored content, or any combination thereof. For example, the user may download podcasts to a computer, and if a podcast is a radio show, the repeating content may be identified in the podcast. In one embodiment, after identifying the repeating content, an alert to the user is provided. For example, the alert may be issued with an indication when the episode of the show was last presented to the user. The episode of the show may be automatically skipped if the episode was presented less than about 30 minutes to about 5 hours before. The marked repeating portion may be optionally removed in operation 705. In operation 707 the marked repeating portion may be optionally saved. In operation 706, the repeating portion may be skipped while presenting non-repeating portion of the content to the user. The repeating portion may be skipped per a user's request, e.g., if the user pushes a button of a remote controller. As shown in FIG. 7, optional operations 704, 705, 706, and 707 are depicted by dashed blocks.

In another embodiment, depending on a user's desire, the marked repeating portion may be muted and the non-repeating portion of the audio content is not muted. In one embodiment, after analyzing 702, an original content may be saved for further processing. For example, a portion in the original content may be falsely identified as a repeating content and removed, to produce a modified content. Then the modified content may be compared with the stored original content using features distinct from the checksums, for example, using actual content, to check if the portion is falsely identified portion and restore it if needed. In one embodiment, method 700 is performed by a web browser. In one embodiment, the repeating content is advertising on a web page.

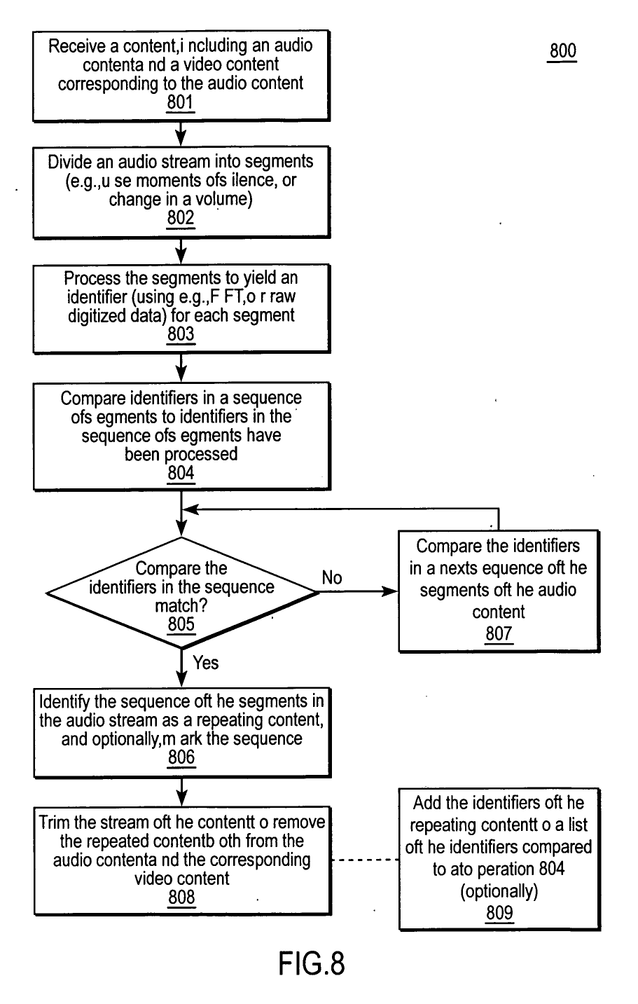

FIG. 8 is a flowchart of one embodiment of a method to detect and process a repeating content including audio and video content. Method 800 begins with operation 801 of receiving a a content, including an audio content and a video content corresponding, e.g., synchronized, to the audio content. In an embodiment, the audio and video contents are streaming contents. At operation 802, the audio content is divided into segments, e.g., using moments of silence, or change in volume, or other indication of a commercial or potentially repetitive content, as described with respect to FIG. 6.

Next, at operation 803, the segments are processed to yield an identifier, using e.g., FFT, checksums, or raw digitized data of an audio signal, as described with respect to FIG. 6. Further, identifiers in a sequence of the segments are compared with the sequence of the segments that have been processed as described with respect to FIGS. 4-6. At operation 805 a determination is made whether the identifiers in the sequence match with the identifiers in the sequence that has been processed. If the identifiers do not match, the identifiers in a next sequence of the segments of the audio stream are compared 807 with the identifiers of the segments have been processed. If the identifiers match, the sequence of the segments in the audio stream is identified 806 as a repeating content, and optionally, marked. Next, at operation 808 the content is trimmed to remove the repeating content both from the audio content and from the corresponding video content. Next, at operation 809 the identifiers of the repeating content may be optionally added to a list of the identifiers used for comparing to at operation 804. That is, in method 800 identifying the repeating audio content is used to modify both the video and audio components of the content.

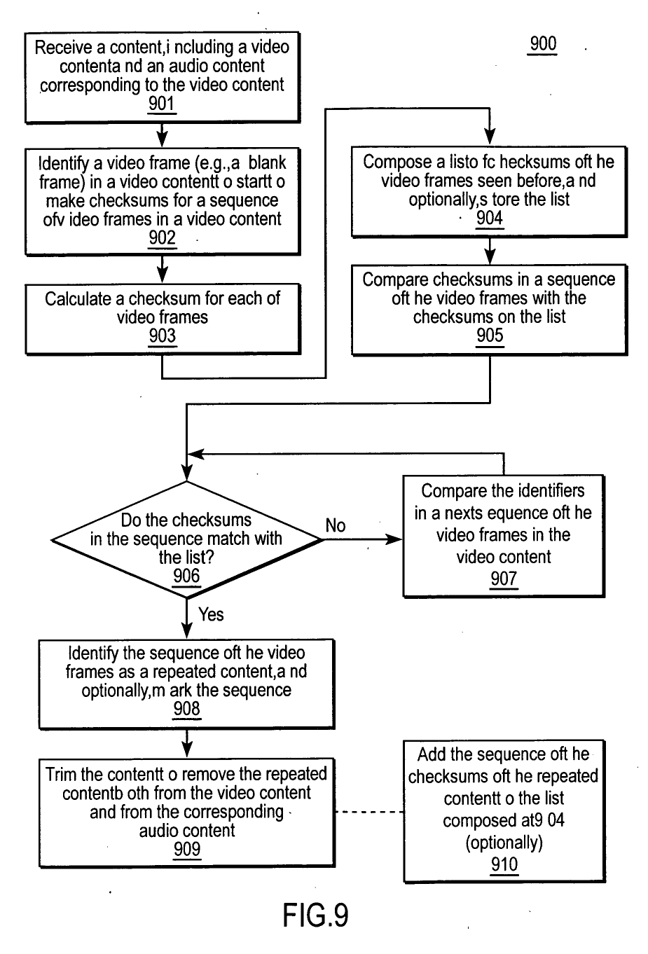

FIG. 9 is a flowchart of another embodiment of a method to detect and process a repeating content including audio and video content. Method 900 begins with operation 901 of receiving a content, including a video content and an audio content corresponding, e.g., synchronized, to the video content. In an embodiment, the audio and video contents are streaming contents. At operation 902, the video frame, e.g. a blank video frame is identified in the video content to start to make checksums for a sequence of the video frames in the video content, as described with respect to FIG. 3. Next, at operation 903, the checksums for each of the video frames are calculated, as described with respect to FIGS. 3 and 4. Further, in operation 904, a list of the checksums for each of the video frames seen before is composed, as described with respect to FIGS. 3 and 4. Next, the checksums in a sequence of the video frames are compared 905 with the sequence of the checksums on the list, as described with respect to FIGS. 3-5. At operation 906 a determination is made whether the checksums in the sequence match with the checksums on the list. If the checksums do not match, the checksums in a next sequence of the video frames are compared 907 with the checksums on the list. If the checksums match, the sequence of the video frames is identified 908 as a repeating content, and optionally, marked. Next, at operation 909 the content is trimmed to remove the repeating content both from the video content and from the corresponding audio content. At operation 910 the sequence of the checksums of the repeated content is optionally added to the list composed at operation 904. That is, in method 900 identifying the repeating video content is used to modify both the video and audio components of the content.

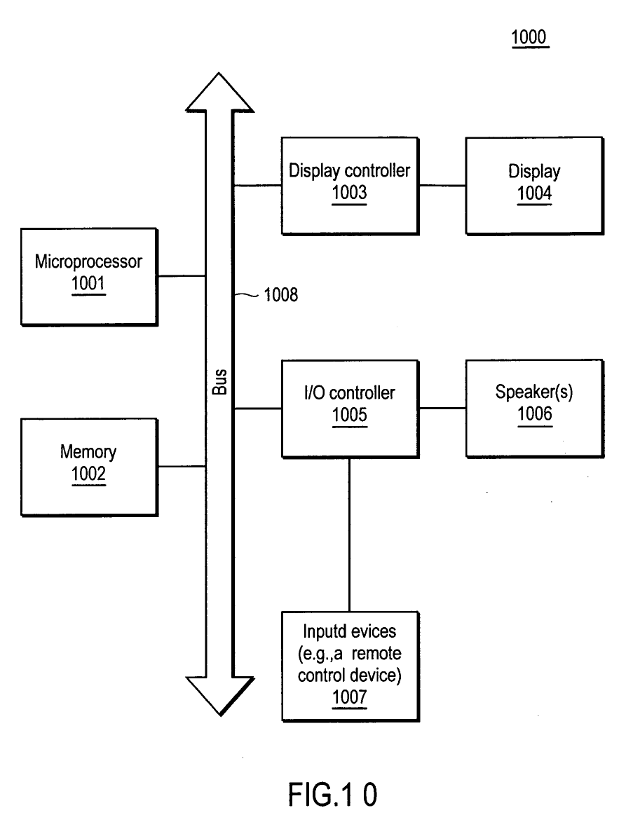

FIG. 10 shows a block diagram of one embodiment of a device 1000 that automatically detects and processes a repeating content. As shown in FIG. 10, device 1000 has a microprocessor 1001 and memory 1002. Software (programs and data) that enable microprocessor 1001 to perform methods of FIGS. 1-9 may be stored onto a read-only memory (not shown) of microprocessor 1000, or onto memory 1002 coupled to microprocessor 1001, e.g., through a bus 1008. Microprocessor 1001 executes the software written onto the memory 1002 or onto the read-only memory to perform methods to automatically detect and process a repeating content as described with respect to FIGS. 1-9. In one embodiment, memory 1002 may be a random access memory (“RAM”), a magnetic disk, a flash memory chip, a hard disk, a battery backed memory, an optical disk, or any other type of machine medium readable by microprocessor 1001. In another embodiment, memory 1002 may include a portable disk, such as a CD-ROM, a DVD, or a floppy disk. Memory 1002 may store identifiers of a content, a list of identifiers for a repeating content, the repeating content, or a combination thereof, as described with respect to FIGS. 1-9.

As shown in FIG. 10, microprocessor 1001 is further coupled to display controller 1003 and I/O controller 1005 through bus 1008. As shown in FIG. 1000, I/0 controller 1005 controls one or more input devices 1007, e.g., a remote control device, or a receiver that receives content, and speakers 1006. As shown in FIG. 10, display controller 1003 controls display 1004 that displays content to a user, as described with respect to FIGS. 1-9.

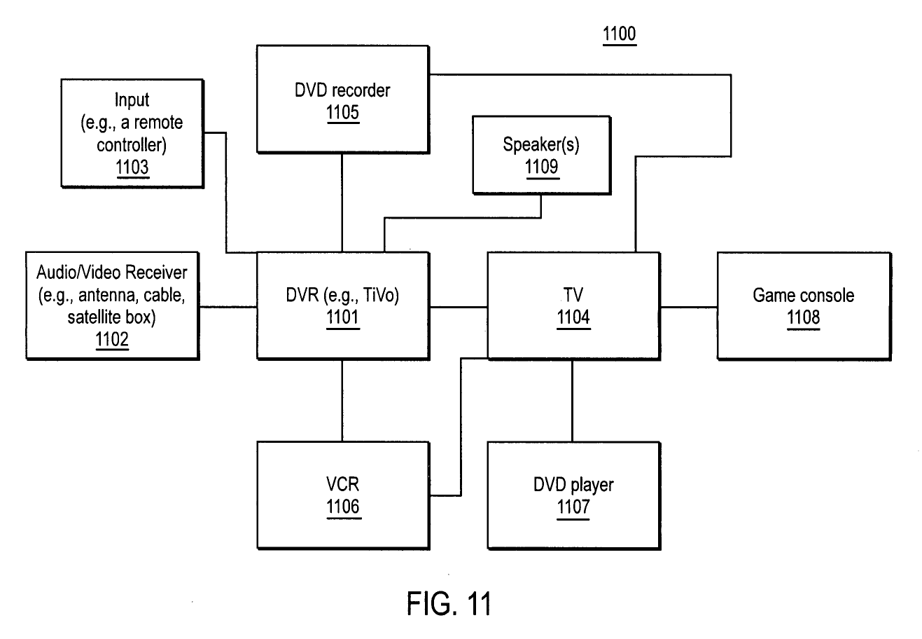

FIG. 11 shows a block diagram of one embodiment of a system 1100, e.g., a home entertainment center that automatically detects and processes a repeating content. As shown in FIG. 11, system 1100 includes a digital video recorder (“DVR”) 1101, for example, TiVo® produced by TiVo Inc., located in Alviso, Calif. DVR 1101 provides digital recording of audio and video content, e.g., TV programs such as content (e.g. movies or TV shows) on demand, and performs methods described with respect to FIGS. 1-9. DVR 1101 is coupled to audio/video receiver 1102, as shown in FIG. 11. Software (programs and data) that enable DVR 1101 to perform methods of FIGS. 1-9 may be stored onto a memory (not shown) of DVR 1101. DVR 1101 executes the software written onto the memory to perform methods to automatically detect and process a repeating content as described with respect to FIGS. 1-9. The memory of DVR 1101 may be a random access memory (“RAM”), a magnetic disk, a flash memory chip, a hard disk, a battery backed memory, an optical disk, or any other type of machine medium readable by DVR 1101. In another embodiment, the memory DVR 1101 may include a portable disk, such as a CD-ROM, a DVD, or a floppy disk. The memory of DVR 1101 may store identifiers of a content, a list of identifiers for a repeating content, the repeating content, or a combination thereof, as described with respect to FIGS. 1-9. It will be appreciated that, in alternative embodiments, another component, rather than or in addition to the DVR, in the system 1100 may be used to perform methods as in FIGS. 1-9. In one embodiment, system 1100 automatically detects and processes the repeating content using methods described in FIGS. 1-9 in response to a user's request.

Audio/video receiver 1101 receives audio and video content (sound and pictures) and sends them to other devices, e.g., DVR 1101, through cables. Audio/video receiver 1102 may be an antenna, a cable, a satellite box, and the like. DVR 1101 is coupled to television set (“TV”) 1104 through a wire or wireless connection. TV 1104 presents audio and video content to a user. As shown in FIG. 11, speakers 1109 are coupled to DVR 1101 to present audio content to the user. As shown in FIG. 11, digital video disk (“DVD”) recorder 1105 and VCR 1106 may be connected between DVR 1101 and TV 1104 to save, e.g. an audio and video content without a repeating content, the repeating content, or both, as described with respect to FIGS. 1-9, to DVD or a video tape. As shown in FIG. 11, game console 1108 and DVD player 1107 may be connected to inputs on TV 1104. Input 1103, e.g. a infrared remote controller 1103, may be connected to DVR 1101 to provide input from the user, as described with respect to FIG. 7.

In one embodiment, DVR 1101 receives a content that includes a repeating content through audio/video receiver 1102. The content may be a TV show with commercials. DVR 1101 presents the content with the repeating content to the user through TV 1104 while receiving the content. DVR 1101 records the content onto a memory of DVR 1101, then detects and processes the repeating content using methods as described above with respect to FIGS. 1-9. After processing, DVR 1101 presents a non-repeating content, wherein the repeating portion is subtracted, to the user. In another embodiment, DVR 1101 presents the repeating portion without presenting the non-repeating portion of the content, to the user. In one embodiment, DVR 1101 stores the information about the repeating content in the memory, and issues an alert to the user when the repeating content is detected, while receiving a TV programming. In one embodiment, DVR 1101 provides an such icon on the screen such as a little icon, e.g., on a comer of a screen of TV 1104, when the repeating content is presented while receiving the TV programming, such that the repeating content may be skipped per user's request.

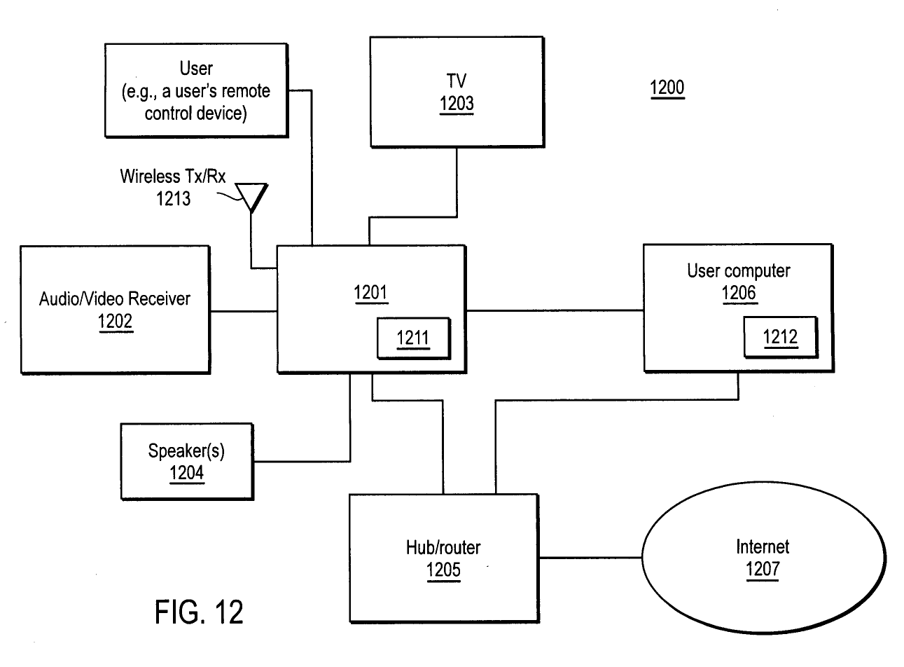

FIG. 12 shows a block diagram of another embodiment of a system 1200 that automatically detects and processes a repeating content. As shown in FIG. 12, system 1200 includes a recorder 1201 that performs methods described with respect to FIGS. 1-9. Device 1201 may be a DVR, such as TiVo®, and audio recorder/player, e.g., iPod or a VCR or any media player, or a telephone, or other types of components or a general purpose data processing system. Device 1201 receives audio and video content, e.g., TV programs, music, radio shows, photos from audio/video receiver 1202, from the Internet 1207, and from a user computer 1206, as shown in FIG. 12. As shown in FIG. 12, device 1201 may receive audio and video content through a wire, or a wireless connection 1213 having transmitter receiver pair (“Tx/Rx”). User computer 1206 may be connected to a plurality of other user computers over a network, e.g., the Internet, local area network (not shown), and wide area network (not shown). In alternate embodiments, user computer 1206 may be a personal computer, a network computer, a Web TV, or other computer system. In one embodiment, device 1201 performs detecting and processing a repeating video and audio content, as described with respect to FIGS. 1-9. In one embodiment, programs and data that enable device 1201 to perform methods of FIGS. 1-9 are stored in a memory 1211 of device 1201. Memory 1211 may be a random access memory (“RAM”), a magnetic disk, a flash memory chip, a hard disk, a battery backed memory, an optical disk, or any other type of machine medium readable by device 1201. In another embodiment, memory 1211 may include a portable disk, such as a CD-ROM, a DVD, and a floppy disk. Memory 1211 may store identifiers of a content, a list of identifiers for a repeating content, the repeating content, or a combination thereof, as described with respect to FIGS. 1-9.

In another embodiment, user computer 1206 performs detecting and processing repeating video and audio content. In one embodiment, the video and audio content to be processed by user computer 1206 is received by device 1201 through audio/video receiver 1202. In one embodiment, user computer 1212 transfers a processed video and audio content to device 1201 to present the processed video and audio content, e .g., the non-repeating audio/video content, the repeating audio/video content, or any combination thereof, onto TV 1203 and speakers 1204, as described with respect to FIGS. 1-9. In one embodiment, programs and data that enable user computer 1206 to perform methods of FIGS. 1-9 are stored in a memory 1212 of user computer 1206. Memory 1212 may be a random access memory (“RAM”), a magnetic disk, a flash memory chip, a hard disk, a battery backed memory, an optical disk, or any machine medium readable by computer 1206. In another embodiment, memory 1212 may include a portable disk, such as a CD-ROM, a DVD, or a floppy disk. Memory 1212 may be used to store identifiers of a content, a list of identifiers for a repeating content, the repeating content, or a combination thereof, as described with respect to FIGS. 1-9. Audio/video receiver 1202 may be an antenna, a cable, a satellite box, and the like. Device 1201 may be connected to TV 1203 through a wire or wireless connection 1213. TV 1203 may present audio and video content received and processed by device 1201, e.g., the non-repeating audio/video content, the repeating audio/video content, or any combination thereof to a user, as described with respect to FIGS. 1-9. As shown in FIG. 12, speakers 1204 are connected to device 1201 to present audio content received and processed by device 1201, e.g., the non-repeating audio content, the repeating audio content, or any combination thereof to the user. As shown in FIG. 12, device 1201 is connected to a user computer 1206 and through a hub/router 1205 (which may be wireless) to the Internet 1207. In one embodiment, audio and video content, e.g., TV/ radio programming, music, e.g., MP3 music files, digital photos, podcasts, may be directly downloaded to device 1201 from the Internet through hub/router 1205. In one embodiment, the audio and video content downloaded through device 1201 may be stored on the user computer 1206. In another embodiment, audio and video content, e.g. TV/radio programming, music, e.g., MP3 music files, digital photos, podcasts may be downloaded to computer 1206 and then transferred to device 1201 per user's request. User's input device 1208, e.g., a remote control device, is coupled to device 1201, as shown in FIG. 12, to provide input from the user, as described with respect to FIG. 7. In one embodiment, device 1205 may share a list of identifiers for a repeating content described with respect to FIGS. 1-9 to a plurality of users e.g., over the Internet 1207, Ethernet, local area network (“LAN”), and wide area network (“WAN”) (not shown). In another embodiment, user computer 1206 shares the list of identifiers for the repeating content to a plurality of users over the Internet 1207, Ethernet, LAN, and WAN (not shown).

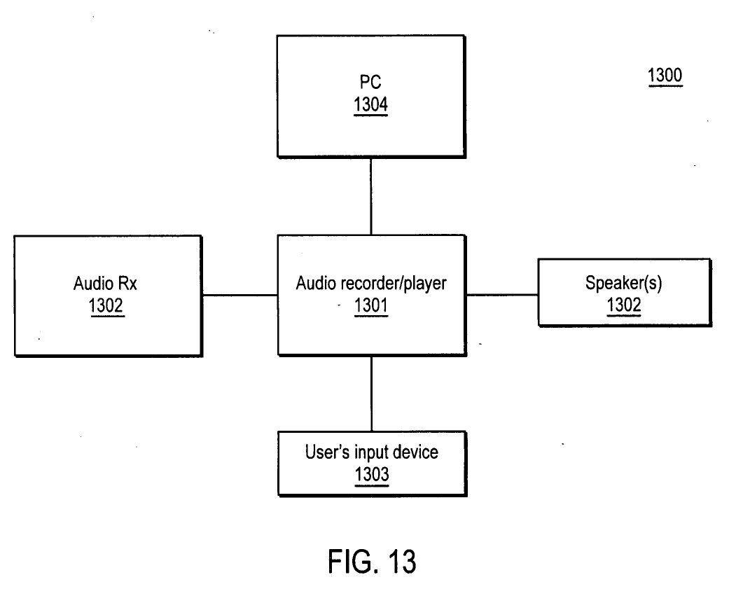

FIG. 13 shows a block diagram of one embodiment of a system 1300 that automatically detects and processes a repeating audio content. As shown in FIG. 13, system 1300 has an audio recorder 1301. Audio recorder/player 1301 may be a MP3 recorder/ player, iPod, or any other device to receive audio content, e.g., music, radio show, podcasting, and the like, automatically detect, and process repeating audio content using methods described with respect to FIGS. 1-9. Software (programs and data) that enable audio recorder/player 1301 to perform methods described above may be stored in a memory (not shown) of audio recorder/player 1301.

In one embodiment, the memory may be a random access memory (“RAM”), a magnetic disk, a flash memory chip, a hard disk, a battery backed memory, an optical disk, or any other machine medium readable by audio recorder/player 1301. In another embodiment, the memory of audio recorder/player 1301 may include a portable disk, such as a CD-ROM, a DVD, or a floppy disk. The memory of audio recorder/player 1301 may store identifiers of the audio content, a list of identifiers for a repeating audio content, the repeating audio content, or a combination thereof, as described with respect to FIGS. 1-9.

As shown in FIG. 13, audio recorder/player 1301 is connected to audio receiver 1302, e.g., an antenna, satellite box, or cable to receive the audio content. Audio recorder/player 1301 is connected to speakers 1302 to present received and processed audio content, e.g., the non-repeating audio content, the repeating audio content, or any combination thereof to the user, as described with respect to FIGS. 1-9. A user input device 1303, e.g., a remote control device, is coupled to audio recorder/player 1301, to receive input from the user, as described above. Audio recorder/player 1301 may be optionally connected to a personal computer (“PC”) 1304, as shown in FIG. 13. In one embodiment, audio recorder/player 1301 receives the audio content trough audio receiver 1302, and transfers the audio content to PC 1304. PC 1304 detects and processes the repeating audio content as described with respect to FIGS. 1-9. In one embodiment, a processed audio content is transferred from PC 1304 back to audio recorder/player 1301. Audio recorder/player 1301 then presents the processed audio content, e.g., the non-repeating audio content, the repeating audio content, or any combination thereof, to the user through speakers 1302. In another embodiment, a processed audio content, e.g., the non-repeating audio content, the repeating audio content, or any combination thereof, is presented to the user by PC 1304.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
determining repetition in a content; and
identifying a repeating content to thereby provide the ability to not present, present the repeating content differently, or remove the repeating content.

2. The method of claim 1, further comprising
removing the repeating content while preserving an information about the repeating content.

3. The method of claim 1, wherein the repeating content is a commercial interspersed among an original content.

4. The method of claim 1, further comprising
using an identified repeating content to identify the repeating content in other content.

5. The method of claim 1, wherein the determining repetition comprises
allocating segments in the content;
processing the segments to yield an identifier for each of the segments; and
comparing identifiers in a sequence of the segments with the identifiers in the sequence of the segments that have been processed.

6. The method of claim 5, wherein the identifier is a checksum.

7. The method of claim 5, wherein the segments are snippets of an audio stream, or video frames.

8. The method of claim 5, wherein the identifying the repeating portion in the content comprises identifying the segments as a repeating content if the identifiers in the sequence of the segments match with the identifiers in the sequence of the segments that have been processed.

9. The method of claim 5, further comprising
composing a list of the identifiers in the sequence of the segments that have been processed.

10. The method of claim 1, further comprising
using information about the repeating portion in the content of a first type to modify a corresponding content of a second type.

11. The method of claim 1, further comprising
skipping the repeating content while presenting an non-repeating content.

12. The method of claim 1, further comprising
presenting the repeating content.

13. The method of claim 1, further comprising
storing the repeating content.

14. A method to detect and process a repeating portion in a streaming content, comprising:
making a checksum for each of video frames;
composing a list of checksums of the video frames seen before;
comparing the checksums in a first sequence of the video frames with the list; and
identifying the first sequence of the video frames as the repeating portion if the checksums in the first sequence match with the list.

15. The method of claim 14, further comprising
sharing the list of the checksums for the repeating portion between a plurality of processing units.

16. The method of claim 14, further comprising
storing the list of the checksums for the repeating portion.

17. The method of claim 14, further comprising
identifying a video frame in a sequence of the video frames to start making the checksum.

18. The method of claim 14, further comprising
comparing the checksums in a next sequence of the video frames with the list if the checksums in the first sequence do not match with the list.

19. The method of claim 14, further comprising
using information about the repeating portion in a video stream to modify an audio stream corresponding to the video stream.

20. An apparatus, comprising:
a processor to determine repetition in a content and to identify a repeating content to thereby provide the ability to not present, present the repeating content differently, or remove the repeating content; and
a memory coupled to the processor.

21. The apparatus of claim 20, wherein the processor
allocates segments in the content,
processes the segments to yield an identifier for each of the segments;
compares identifiers in a sequence of the segments with the identifiers in the sequence of the segments that have been processed; and
identifies the segments as a repeating content if the identifiers in the sequence of the segments match with the identifiers in the sequence of the segments that have been processed.

22. The apparatus of claim 20, wherein the content is a video stream, an audio stream, or a combination thereof.

23. The apparatus of claim 20, wherein the repeating content is a commercial interspersed among an original content.

24. The apparatus of claim 20, wherein the memory stores information about the repeating content.

25. The apparatus of claim 20, wherein the processor
removes the repeating content while preserving the information about the repeating content.

26. The apparatus of claim 20, wherein the processor uses
information about the repeating portion in a first content to modify a second content corresponding to the first content.

27. The apparatus of claim 20, further comprising
an input coupled to the processor to input a content and
an output coupled to the processor to output the content.

28. An article of manufacture comprising:
a machine-accessible medium including data that, when accessed by a machine, cause the machine to perform operations comprising,
determining repetition in a content; and
identifying a repeating content to thereby provide the ability to not present, or present the repeating content differently, or remove the repeating content.

29. The article of manufacture of claim 28, wherein the machine-accessible medium further includes data that cause the machine to perform operations comprising,
removing the repeating content while preserving information about the repeating content.

30. The article of manufacture of claim 28, wherein the machine-accessible medium further includes data that cause the machine to perform operations comprising,
using an identified repeating content to identify the repeating content in other content.

31. The article of manufacture of claim 28, wherein the determining repetition comprises
allocating segments in the content;
processing the segments to yield an identifier for each of the segments; and
comparing identifiers in a sequence of the segments with the identifiers in the sequence of the segments that have been processed.

32. The article of manufacture of claim 31, wherein the identifier is a checksum.

33. The article of manufacture of claim 31, wherein the segments are video frames.

34. The article of manufacture of claim 31, wherein the segments are snippets of an audio stream.

35. The article of manufacture of claim 31, wherein the identifying the repeating portion in the content comprises identifying the segments as a repeating content if the identifiers in the sequence of the segments match with the identifiers in the sequence of the segments that have been processed.

36. The article of manufacture of claim 31, wherein the machine-accessible medium further includes data that cause the machine to perform operations comprising,
composing a list of the identifiers in the sequence of the segments that have been processed.

37. The article of manufacture of claim 28, wherein the machine-accessible medium further includes data that cause the machine to perform operations comprising,
using information about the repeating portion in a first content to modify a second content corresponding to the first content.

38. The article of manufacture of claim 28, wherein the machine-accessible medium further includes data that cause the machine to perform operations comprising,
skipping the repeating content while presenting an non-repeating content.

39. The article of manufacture of claim 28, wherein the machine-accessible medium further includes data that cause the machine to perform operations comprising,
presenting the repeating content.

40. The article of manufacture of claim 28, wherein the machine-accessible medium further includes data that cause the machine to perform operations comprising,
storing the repeating content.

41. An article of manufacture comprising:
a machine-accessible medium including data that, when accessed by a machine, cause the machine to perform operations comprising,
making a checksum for each of video frames;
composing a list of checksums of the video frames seen before;
comparing the checksums in a first sequence of the video frames with the list; and
identifying the first sequence of the video frames as the repeating portion if the checksums in the first sequence match with the list.

42. The article of manufacture of claim 41, wherein the machine-accessible medium further includes data that cause the machine to perform operations comprising,
sharing the list of the checksums for the repeating portion between a plurality of processing units.

43. The article of manufacture of claim 41, wherein the machine-accessible medium further includes data that cause the machine to perform operations comprising,
storing the list of the checksums for the repeating portion.

44. The article of manufacture of claim 41, wherein the machine-accessible medium further includes data that cause the machine to perform operations comprising,
identifying a video frame in a sequence of the video frames to start making the checksum.

45. The article of manufacture of claim 41, wherein the machine-accessible medium further includes data that cause the machine to perform operations comprising,
comparing the checksums in a next sequence of the video frames with the list if the checksums in the first sequence do not match with the list.

46. The article of manufacture of claim 41, wherein the machine-accessible medium further includes data that cause the machine to perform operations comprising,
using information about the repeating portion in a video stream to modify an audio stream corresponding to the video stream.

47. A system to detect and process a repeating content, comprising
means for determining repetition in a content; and
means for identifying a repeating content to thereby provide the ability to not present, or present the repeating content differently, or remove the repeating content.

48. The system of claim 47, further comprising
means for removing the repeating content while preserving information about the repeating content.

49. The system of claim 47, further comprising
means for using an identified repeating content to identify the repeating content in other content.

50. The system of claim 47, wherein the means for determining repetition comprise
means for allocating segments in the content;
means for processing the segments to yield an identifier for each of the segments; and
means for comparing identifiers in a sequence of the segments with the identifiers in the sequence of the segments that have been processed.

51. The system of claim 50, wherein the means for identifying the repeating portion in the content comprise means for identifying the segments as a repeating content if the identifiers in the sequence of the segments match with the identifiers in the sequence of the segments that have been processed.

52. The system of claim 50, further comprising
means for composing a list of the identifiers in the sequence of the segments that have been processed.

53. The system of claim 47, further comprising
means for using information about the repeating portion in a first content to modify a second content corresponding to the first content.

54. The system of claim 47, further comprising
means for skipping the repeating content while presenting an non-repeating content.

55. The system of claim 47, further comprising
means for presenting the repeating content.

56. The system of claim 47, further comprising
means for storing the repeating content.

57. A system to detect and process a repeating portion in a streaming content, comprising:
means for making a checksum for each of video frames;
means for composing a list of checksums of the video frames seen before;
means for comparing the checksums in a first sequence of the video frames with the list; and
means for identifying the first sequence of the video frames as the repeating portion if the checksums in the first sequence match with the list.

58. The system of claim 57, further comprising
means for sharing the list of the checksums for the repeating portion between a plurality of processing units.

59. The system of claim 57, further comprising
means for storing the list of the checksums for the repeating portion.

60. The system of claim 57, further comprising
means for identifying a video frame in a sequence of the video frames to start making the checksum.

61. The system of claim 57, further comprising
means for comparing the checksums in a next sequence of the video frames with the list if the checksums in the first sequence do not match with the list.

62. The system of claim 57, further comprising
means for using information about the repeating portion in a video stream to modify an audio stream corresponding to the video stream.

63. A method, comprising:
determining repetition in a content; and
analyzing the content to thereby provide the ability to not present, present the repeating content differently, or remove the repeating content, wherein the content is not a blank content and is not otherwise marked.

64. A method, comprising:
detecting commercials in a content based on repetition of content in commercials; and
identifying the commercials to thereby provide the ability to not present, present the commercials differently, or remove the commercials.

65. A method, comprising:
detecting repetition in a podcast; and
identifying a repeating content in the podcast to thereby provide the ability to not present, present the repeating content differently, or remove the repeating content.

66. A media player device, comprising:
a processor to detect repetition in a content and to identify a repeating content to thereby provide the ability to not present, present the repeating content differently, or remove the repeating content; and
a memory coupled to the processor, the memory store at least some of the content for presentation.

67. An article of manufacture comprising:
a machine-accessible medium including data that, when accessed by a machine, cause the machine to perform operations comprising,
determining repetition in a content; and
analyzing the content to thereby provide the ability to not present, present the repeating content differently, or remove the repeating content, wherein the content is not a blank content and is not otherwise marked.

68. An article of manufacture comprising:
a machine-accessible medium including data that, when accessed by a machine, cause the machine to perform operations comprising,
detecting commercials in a content; and
identifying the commercials to thereby provide the ability to not present, present the commercials differently, or remove the commercials.

69. An article of manufacture comprising:
a machine-accessible medium including data that, when accessed by a machine, cause the machine to perform operations comprising,
detecting repetition in a podcast; and
identifying a repeating content in the podcast to thereby provide the ability to not present, present the repeating content differently, or remove the repeating content.
